(19) United States
(12) Patent Application Publication
(10) Pub. No.: US 2006/0203280 A1
(43) Pub. Date: Sep. 14, 2006

(54) Image printing apparatus and image printing method

(75) Inventors: Masa-aki Kobayashi, Kasuga-shi (JP); Yukihiro Nishida, Fukuoka-shi (JP)

Correspondence Address: GREENBLUM & BERNSTEIN, P.L.C., 1950 ROLAND CLARKE PLACE, RESTON, VA, 20191, US

(73) Assignee: Matsushita Electric Industrial Co., Ltd., Osaka (JP)

(21) Appl. No.: 11/360,493

(22) Filed: Feb. 24, 2006

(30) Foreign Application Priority Data
Aug. 18, 2005 (JP) P. 2005-237174
Feb. 25, 2005 (JP) 2005-050433

(51) Int. Cl. G06K 15/00

(52) U.S. Cl. 358/1.14; 358/1.9; 358/518

(57) ABSTRACT

There is provided an image printing apparatus having color materials of a plurality of colors including black and performing color printing using the plurality of color materials. The image printing apparatus includes a data acquisition interface that acquires color printing data (PDL data, etc.), a residual amount detection unit that detects the residual amount of the plurality of color materials, a drawing unit that draws the color printing data acquired by the data acquisition interface as printing data that is printable with a color material of black when the residual amount detection unit has detected that the residual amount of at least one color material excluding black is a predetermined amount or less, and a recording unit that executes printing processing on the basis of the printing data drawn by the drawing unit.

### FIELD OF THE INVENTION

The present invention relates to an image printing apparatus and an image printing method that perform color printing using color materials of black, cyan, magenta, yellow, etc.

### BACKGROUND

In related printing apparatuses, if it is detected that the residual amount of color materials (chromatic color materials) of cyan, magenta, yellow, etc. or a color material of black (black material) is a predetermined amount or less, a control to stop printing is performed because color cannot be substantially reproduced.

However, in the related printing apparatuses that performs a control to stop printing when the residual amount of the color materials is a predetermined amount or less, for example, if it is detected that the residual amount of one of the chromatic color materials of three colors of cyan, magenta and yellow and black material is a predetermined amount or less, printing processing based on printing data is not performed. As a result, the printing apparatuses have a problem in that printing results (printed materials) cannot be obtained.

### SUMMARY

The invention provides an image printing apparatus having color materials of a plurality of colors and performing color printing using the plurality of color materials. The apparatus includes a data acquisition interface which acquires color printing data, an instruction storage memory which stores a monochrome printing instruction, a drawing unit which draws the color printing data acquired by the data acquisition interface as printing data being printable with a monochrome material when a monochrome printing instruction is stored in the instruction storage memory, and a recording unit which executes printing processing on the basis of the printing data drawn by the drawing unit.

Further, when a residual amount detection unit has detected that the residual amount of at least one color material is a predetermined amount or less, the color printing data acquired by the data acquisition interface is drawn as printing data being printable with the other monochrome materials, and printing processing is then executed.

### BRIEF DESCRIPTION OF THE SEVERAL VIEWS OF DRAWING

FIG. 1 shows the system configuration of an image printing apparatus according to Embodiment 1 of the invention;

FIG. 2 shows the hardware configuration of the image printing apparatus according to Embodiment 1 of the invention;

FIG. 3 shows the functional configuration of the image printing apparatus according to Embodiment 1 of the invention;

FIG. 4 is a flow chart of the operation of the image printing apparatus according to Embodiment 1 of the invention;

FIG. 5 shows the functional configuration of an image printing apparatus according to Embodiment 2 of the invention;

FIG. 6 is a flow chart of the operation of the image printing apparatus according to Embodiment 2 of the invention;

FIG. 7 shows the functional configuration of an image printing apparatus according to Embodiment 3 of the invention;

FIG. 8 is a flow chart of the operation of the image printing apparatus according to Embodiment 3 of the invention;

FIG. 9 shows the functional configuration of an image printing apparatus according to Embodiment 4 of the invention;

FIG. 10 is a flow chart of the operation of the image printing apparatus according to Embodiment 4 of the invention;

FIG. 11 shows the functional configuration of an image printing apparatus according to Embodiment 5 of the invention;

FIG. 12 is a flow chart of the operation of the image printing apparatus according to Embodiment 5 of the invention;

FIG. 13 shows the hardware configuration of an image processing device according to Embodiment 6 of the invention;

FIG. 14 shows the functional configuration of an image processing device according to Embodiment 6 of the invention;

FIG. 15 is a flow chart of the operation of the image processing device according to Embodiment 6 of the invention;

FIG. 16 shows an example of a lookup table according to Embodiment 6 of the invention;

FIG. 17 is an explanatory view of the operation in monochrome conversion processing according to Embodiment 6 of the invention;

FIG. 18 is an explanatory view of gradation conversion processing according to Embodiment 6 of the invention;

FIG. 19 is an explanatory view of gradation conversion processing according to Embodiment 6 of the invention;

FIG. 20 is an explanatory view of gradation conversion processing according to Embodiment 6 of the invention;

FIG. 21 shows the functional configuration of an image processing device according to Embodiment 7 of the invention; and

FIG. 22 is a flow chart of the operation of the image processing device according to Embodiment 7 of the invention.

### DETAILED DESCRIPTION

Although respective embodiments of the invention are described below, the contents of the respective embodiments are used for one another.

(Embodiment 1)

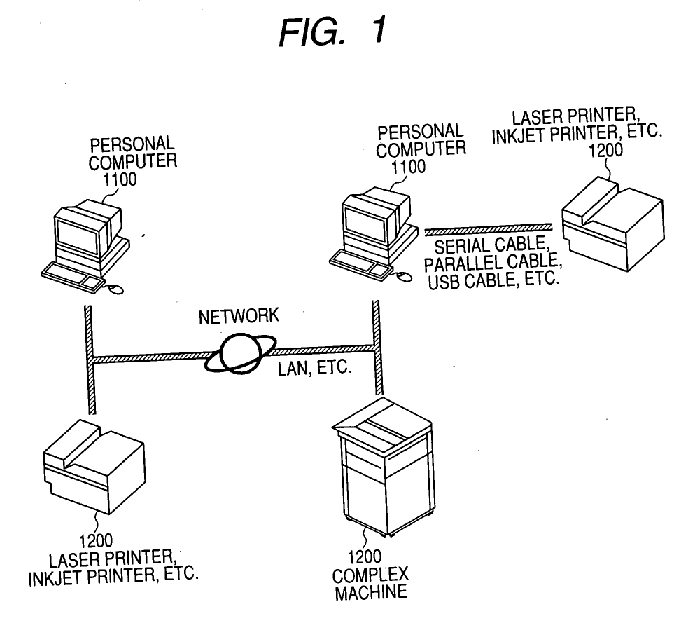

FIG. 1 shows the system configuration of an image printing apparatus according to Embodiment 1 of the invention.

In FIG. 1, host computers 1100 such as personal computers and image printing apparatuses 1200 such as a laser printer and inkjet printer are communicably connected to one another via serial cables, parallel cables, and USB cables or otherwise over networks such as LANs.

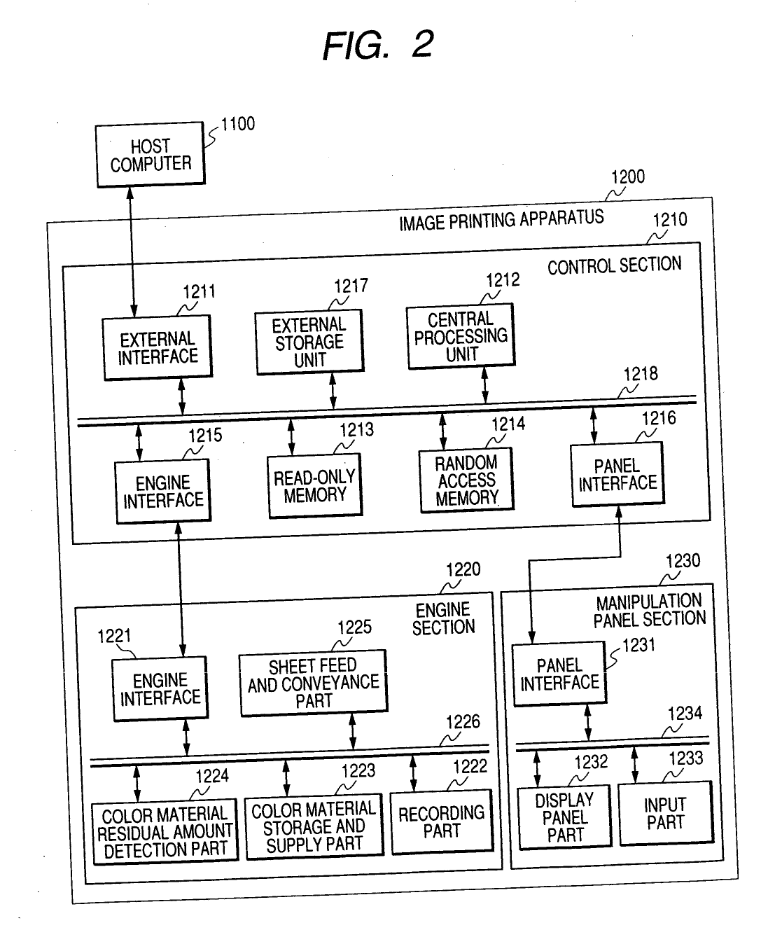

FIG. 2 shows the hardware configuration of the image printing apparatus according to Embodiment 1 of the invention.

In FIG. 2, a host computer 1100 and a hardware computer 1200 are connected to each other via a communication line, for example, a wire communication line or a wireless communication line, such as a communication cable, a LAN (Local Area Network) or an Internet.

The host computer 1100 transmits data (hereinafter referred to as “PDL data”) described in a page description language (hereinafter referred to as “PDL”), printing data, etc. to the image printing apparatus 1200 via a communication line.

The image printing apparatus 1200 includes a controller section 1210, an engine section 1220, and a manipulation panel section 1230, and executes printing processing of an image according to data signals received via a communication line.

The controller section 1210 creates printing data for recording on the basis of PDL data or printing data from the host computer 1110 received via a communication line.

The controller section 1210 also performs overall control of the engine section 1220. Specifically, the controller section transmits the created printing data to the engine section 1220 as video signals, and notifies a user of information showing states of the engine section 1220, which is obtained by carrying out communication with the engine section 1220, by transmitting the information to the host computer 1100 or the manipulation panel section 1230. Here, the information includes the residual amount of consumption articles such as color materials, or malfunctions in printing processing such as jamming.

The engine section 1220 receives the video signals from the controller section 1210, and prints printing data based on the video signals on a recording medium such as a recording sheet.

The manipulation panel section 1230 receives signals transmitted from the controller section 1210 to display the information showing states of the engine section 1220 on the basis of the received signals, and transmits various kinds of setting information of printing processing or external interface based on information input by panel manipulation from a user, to the controller section 1210. The controller section 1210 controls printing processing on the basis of the various setting information from the manipulation panel section 1230.

Next, the hardware configuration of the above-described image printing apparatus 1200 will be described.

As shown in FIG. 2, the controller section 1210 includes an external interface 1211, a central processing unit (hereinafter referred to as “CPU”) 1212, a read-only memory (hereinafter referred to as “ROM”) 1213, a random access memory (hereinafter referred to as “RAM”) 1214, an engine interface 1215, a panel interface 1216, and an external storage unit 1217. These respective components are bus-coupled to one another by a database 1218.

The external interface 1211 performs data transmission/reception with the host computer 1100 via a communication line.

The CPU 1212 performs the control of the whole apparatus, such as memory management and job management, for optimally using storage regions of the RAM 1214 according to the storage capacity thereof, and creates printing data (bitmap information) by performing various kinds of image processing, such as interpretation of PDL data, drawing of printing data based on results of the interpretation of the PDL data, and color conversion or gradation conversion suitable for printing apparatuses.

The ROM 1213 stores programs and font information that control the image printing apparatus. The RAM 1214 stores data transmitted from the host computer 1100, printing data, etc. and stores a color material residual amount flag.

The engine interface 1215 serves as an interface to perform the data transmission/reception with the engine section 1220.

The panel interface 1216 transmits data to be displayed on the manipulation panel section 1230 and receives data set by input manipulation of the manipulation panel section 1230 by a user.

The external storage unit 1217 temporarily stores PDL data or printing data. Here, as a user manipulates the host computer 1100, the PDL data or printing data is transmitted from the host computer 1100 to the image printing apparatus 1200, and as the user manipulates the manipulation panel section 1230 of the image printing apparatus 1200, the external storage unit temporarily stores the PDL data or printing data for security printing that starts printing processing after verification of a user ID.

The data to be transmitted or received within the controller section 1210 is transmitted to the database 1218.

Further, in the image printing apparatus 1200, as shown in FIG. 2, the engine section 1220 includes an engine interface 1221, a recording part 1222, a color material storage and supply part 1223, a color material residual amount detection part 1224, and a sheet feed and conveyance part 1225. These respective components are bus-coupled to one another by a data bus 1226.

The engine interface 1221 performs data reception and transmission with the controller section 1210.

The recording part 1222 performs printing processing on a recording medium such as a recording sheet on the basis of printing data received by the engine interface 1221. Here, in a case in which the image printing apparatus is a printer using electrophotographic processing, a recording part of the printer is composed of various components such as a charging part, an exposing part, a developing part, a transfer part, a fixing part, and a cleaning part.

The color material storage and supply part 1223 stores a color material and supplies the recording part 1222 with a color material having an amount needed for printing processing. Here, the color material is a toner in a case in which the printer uses an electromagnetic method, the color material is a liquid ink in a case in which the printer uses an inkjet method, and the color material is an ink ribbon in a case in which the printer uses a sublimation method. Further, as specific examples of the color material in the case in which the printer uses an electrophotographic method, there are toners (color materials) of respective colors, such as cyan, magenta, yellow and black.

In addition, in the present specification, a color material of black is defined as a black material, and color materials of colors other than black, for example, cyan, magenta and yellow are defined as chromatic color materials.

The color material residual amount detection part 1224 is composed of a sensor and detects the residual amount of the black material and the chromatic color materials. Incidentally, specific structures for detecting the residual amount of color materials are disclosed in US2005-185973A1 and US2004-01724A1, etc., which use toner as the color materials, and US2003-025741A1, US2003-025742A1 and US2003-025743A1, etc., which use ink as the color materials. The sheet feed and conveyance part 1225 feeds and conveys a recording medium such as a recording sheet used to perform printing processing.

The data to be transmitted or received within the engine section 1220 is transmitted to the data bus 1226.

Moreover, in the image printing apparatus 1200, as shown in FIG. 2, the manipulation panel section 1230 includes a panel interface 1231, a display panel part 1232, and an input part 1233. These respective components are bus-coupled to one another by a database 1234.

The panel interface 1231 performs data transmission/reception with the controller section 1210.

The display panel part 1232 and the input part 1233 are parts that serve as user interfaces. The display panel part 1232 displays data from the controller section 1210 that is received via the panel interface 1231, and also displays input data corresponding to input manipulation of the input part 1233 by a user, according to control of the controller section 1210. The input part 1233 is composed of buttons, a touch panel, etc. that allow a user to input various setting values.

The data to be transmitted or received within the manipulation panel section 1230 is transmitted to the database 1234.

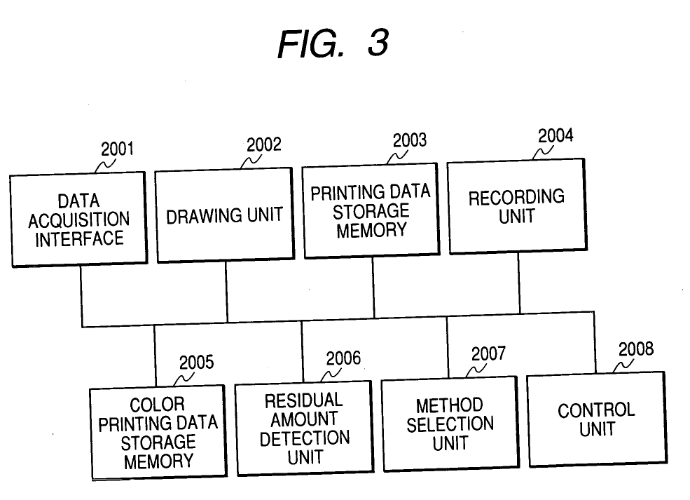

Next, the functional configuration of the image printing apparatus shown in FIG. 2 will be described referring to FIG. 3.

FIG. 3 is a functional block diagram of the image printing apparatus according to Embodiment 1 of the invention.

In FIG. 3, a data acquisition interface 2001 inputs (acquires) PDL data (color printing data).

A drawing unit 2002 interprets the PDL data to draw bitmap data.

A printing data storage memory 2003 stores printing data created by the drawing unit 2002.

A recording unit 2004 executes printing processing on a recording medium (such as a recording sheet) on the basis of video signals transmitted to the engine section 1220 from the controller section 1210.

A color printing data storage memory 2005 stores the PDL data until the end of the printing processing.

A residual amount detection unit 2006 detects the residual amount of a color material such as a black material and chromatic color materials.

A method selection unit 2007 selects and processes printing control processing that is performed when the residual amount of a color material becomes a predetermined amount or less.

A control unit 2008 performs overall control of the whole image printing apparatus, i.e., the above respective means.

Now, the correspondence relation between the respective components of the image printing apparatus shown in FIG. 3 and the respective components of the image printing apparatus shown in FIG. 2 will be described.

The data acquisition interface 2001 is realized by the external interface 1211.

The drawing unit 2002 is realized as the CPU 1212 loads a control program stored in the ROM 1213 to the RAM 1214 to execute the control program.

The printing data storage memory 2003 and the color printing data storage memory 2005 are realized by the RAM 1214 or the external storage unit 1217.

The recording unit 2004 is realized by the recording part 1222, the color material storage and supply part 1223, and the sheet feed and conveyance part 1225.

The residual amount detection unit 2006 is realized by the color material detection part 1224.

The method selection unit 2007 is realized by the display panel part 1232 and the input part 1233 of the manipulation panel section 1230. Specifically, the method selection unit 2007 is realized by switching a control method of the controller section 1210 on the basis of input information according to user input from the display panel part 1232 or the input part 1233.

In addition, the input information in the method selection unit 2007 may be a form that is performed upon reception of an instruction from a user during printing processing operation or may be a form in which information of contents instructed in advance by a user is stored in the RAM 1214, etc. and the user refers to the information, if necessary.

A control program for carrying out the overall control of the respective means is stored in the ROM 1213. The control unit 2008 loads the control program from the ROM 1213 to the RAM 1214, and executes this program to thereby perform overall control of the whole image printing apparatus, i.e., the above respective means.

The printing operation of the image printing apparatus configured as above will be described.

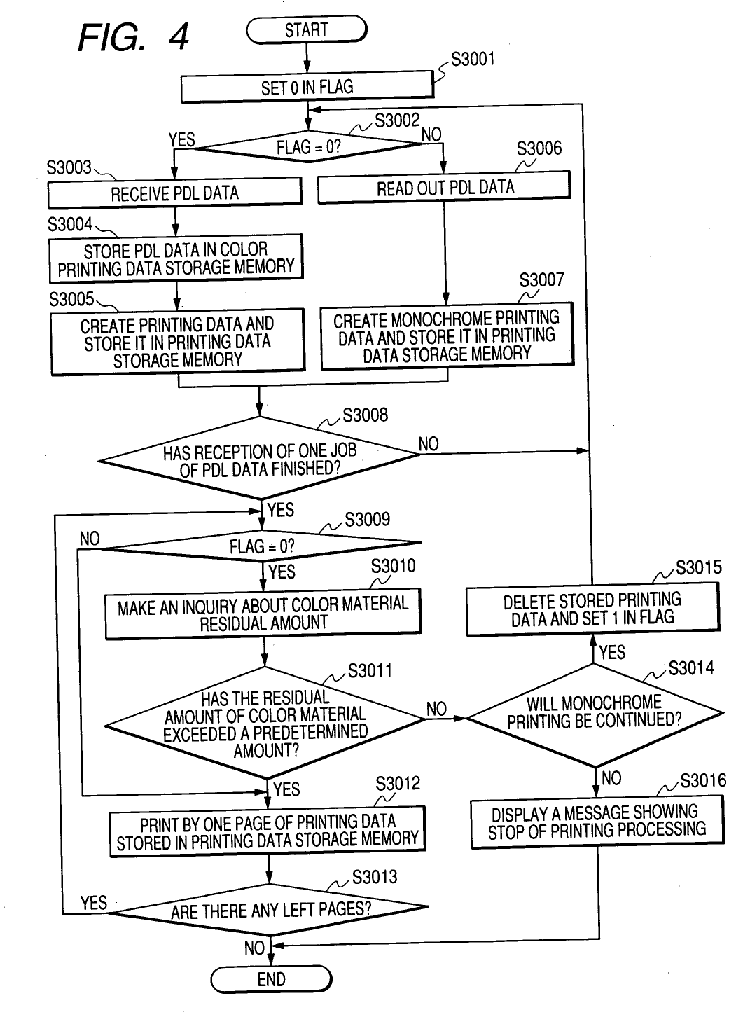

FIG. 4 is a flow chart showing printing processing operation of the image printing apparatus according to Embodiment 1 of the invention.

As shown in FIG. 4, the control unit 2008 sets “0” in a color material residual amount flag before receiving one page of PDL data (S3001), and thereafter determines whether or not the color material residual amount flag is “0” (S3002).

In S3002, the control unit 2008 that has determined that the color material residual amount flag is “0” receives PDL data transmitted from the host computer 1100 via the data acquisition interface 2001 (S3003) and stores the received PDL data in the color printing data storage memory 2005 (S3004). Thereafter, the control unit requests the drawing unit 2002 to perform drawing processing of the printing data.

The drawing unit 2002 that has received the request to perform drawing processing from the control unit 2008 in this way reads out the PDL data stored in the color printing data storage memory 2005, interprets the read-out PDL data, draws printing data on the basis of the interpreted result, and stores the drawn (created) printing data in the printing data storage memory 2003 (S3005). The drawing unit 2002 that has finished S3005 notifies the control unit 2008 that the drawing processing has been finished.

On the other hand, in S3002, the control unit 2008 that has determined that the color material residual amount flag is “1” requests the drawing unit 2002 to perform drawing processing of printing data. The drawing unit 2002 that has received the request to perform drawing processing reads out the PDL data from the color printing data storage memory 2005 (S3006), interprets the read-out PDL data, draws printing data that is printable with a color material of black on the basis of the interpreted results, and stores the drawn (created) printing data in the printing data storage memory 2003 (S3007).

In addition, the printing data that is printable with a color material of black includes 8-bit continuous tone data of a single black.

The drawing unit 2002 that has finished the S3007 notifies the controls unit 2008 that the drawing processing has been finished.

Incidentally, the processing of S3007 can be executed, for example, when the residual amount of a color material (that is, one color material of chromatic color materials) of at least one color other than black among color materials of a plurality of colors including black becomes a predetermined amount or less.

The control unit 2008 that has received the notification that the drawing processing has been finished, from the drawing unit 2002 that has finished S3005 or S3007, determines whether or not one page of PDL data has been completely received (S3008).

In S3008, if the control unit determines that one page of PDL data has not yet been completely received, it returns to S3002, and repeats the processing of the above-mentioned S3002 to S3008 until one page of PDL data has been completely received.

On the other hand, in S3008, the control unit 2008 that has determined that one page of PDL data has been completely received determines whether or not the color material residual amount flag is “0” (S3009). As a result of this determination, if the color material residual amount flag is “0,” the control unit makes an inquiry to the residual amount detection unit 2006 about the residual amount of a color material (S3010), and then determines whether or not the residual amount of a color material needed for printing exceeds a predetermined amount on the basis of the inquiry result from the residual amount detection unit 2006 (S3011).

In S3011, if the control unit 2008, which has determined that the residual amount of a chromatic color material when the printing data is printable with only a black material or when the printing data also needs chromatic color materials has exceeded a predetermined amount, reads out one page of printing data stored in the printing data storage memory 2003, and transmits the read-out data to the recording unit 2004, the recording unit 2004 executes printing processing on the basis of the one page of printing data received (S3012).

When S3012 has been finished, the control unit 2008 determines whether or not pages to be printed are left (S3013). As a result of this determination, if there are any left pages, the control unit returns to S3009, and repeats the processing of the above-mentioned S3009 to S3013 until any left pages do not exist, while the control unit finishes this processing if there is no left page.

On the other hand, if the control unit determines in S3009 that the color material residual amount flag is “1,” it proceeds to S3012.

Further, the control unit 2008 that has determined in S3011 that the residual amount of a color material is a predetermined amount or less makes an inquiry to the method selection unit 2007 about whether or not monochrome printing will be performed.

Then, the method selection unit 2007 determines whether or not the monochrome printing will be continued, on the basis of information showing a control method set according to input manipulation of the manipulation panel section 1230 by a user (S3014), and sends the determined result back to the control unit 2008 as an inquiry result about the above inquiry.

The control unit 2008 that has received the inquiry result sent back from the method selection unit 2007, if the inquiry result shows that the monochrome printing will be continued, deletes the printing data stored in the printing data storage memory 2003, and updates the color material residual amount flag, in which “0” is set, from “0” to “1” (sets “1” in the color material residual amount flag) (S3015), and thereafter returns to S3002.

Meanwhile, if the inquiry result sent back from the method selection unit 2007 that has executed S3014 shows that the monochrome printing will not be continued, that is, the inquiry result shows stop of the printing processing, the control unit 2008 causes a message that the printing processing will be stopped to be displayed on the display panel part 1232 of the manipulation panel section 1230 (S3016), and finishes this processing.

In addition, in Embodiment 1, as the printing data to be drawn (created) by the drawing unit 2002, that is, as the color printing data to be stored in the printing data storage memory 2003 in Step S3005, there are bitmap data drawn by RGB 8-bits, continuous tone printing data such as bitmap data color-converted to CMYK 8-bit data, and halftone printing data gradation-converted to CMYK 1-bit or n-bit data.

Further, in Embodiment 1, in a case in which the printing data is bitmap data drawn by RGB 8-bits or continuous tone printing data such as bitmap data color-converted to CMYK 8-bit data, when the printing data (color printing data) is transmitted to the engine section 1220 to thereby start printing processing, it is necessary to perform color conversion processing or gradation conversion processing, and to transmit video signals to the engine section 1220 while creating halftone printing data.

As described above, according to Embodiment 1, when the residual amount detection unit 2006 has detected that the residual amount of a color material (that is, one color material of chromatic color materials) of at least one color other than black becomes a predetermined amount or less, the drawing unit 2002 is adapted to draw printing data (monochrome printing data) that is printable with a color material of black (black material) on the basis of the PDL data stored in the color printing data storage memory 2005. Thus, when the residual amount of a color material of at least one color other than black becomes a predetermined amount or less, the image printing apparatus can provide a monochrome printing result in which a whole image is monochrome-printed without providing a color printing result caused by unnatural color printing unlike a related image printing apparatus.

Further, according to Embodiment 1, basic data used to draw printing data that is printable with a color material of black, for example, the PDL data (color printing data) is stored in the color printing data storage memory 2005 serving as the external storage unit. Thus, the memory efficiency of a main storage means (for example, the RAM 1214) to perform drawing processing and image processing can be improved, and the printing processing efficiency can be improved.

Further, during printing that utilizes the external storage unit 1217, such memory printing, even if the residual amount of a color material of at least one color other than black becomes a predetermined amount or less, a whole image can be monochrome-printed.

In addition, although a form in which monochrome printing is performed when the residual amount of at least one chromatic color material becomes a predetermined amount or less is illustrated in the present embodiment, a color to be printed is not limited to black. For example, when the residual amount of at least one color material becomes a predetermined amount or less, a form in which monochrome printing is performed with any other color material having a predetermined residual amount may be employed. In this case, if there are a plurality of color materials having a predetermined amount, a color material having a greatest residual amount may be used, or the color materials may be sequentially used in the order of priority given in advance by a user.

Further, although a form in which, when the residual amount of a color material becomes a predetermined amount or less, printing is performed after the printing data is converted to monochrome printing data, is illustrated in the present embodiment, printing may be performed after acquired color printing data is compulsorily converted to monochrome printing data by an image printing apparatus, by performing mode setting (storing a mode setting flag in the RAM 124, etc.) that performs monochrome printing at all times by the user setting as in S3014.

Accordingly, even if a host computer does not receive an instruction of monochrome printing, an image printing apparatus can automatically perform the monochrome printing.

(Embodiment 2)

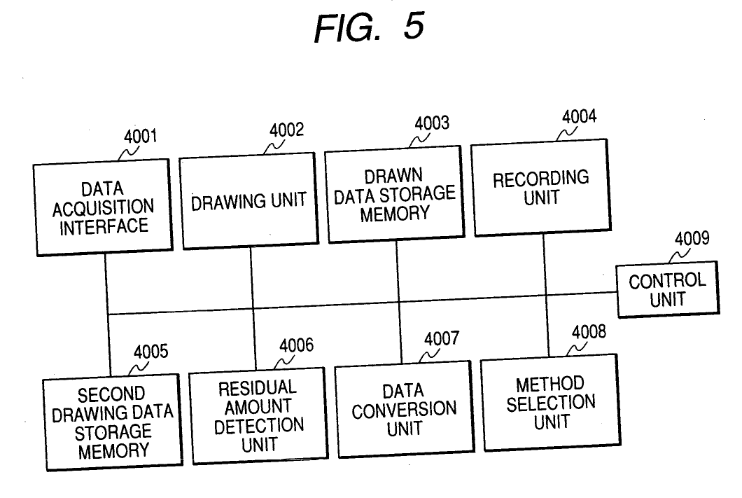

FIG. 5 is a functional block diagram of an image printing apparatus according to Embodiment 2 of the invention.

Since the hardware configuration of the image printing apparatus according to Embodiment 2 is the same as the configuration of the image printing apparatus according to Embodiment 1 shown in FIG. 2, the description thereof is omitted herein.

In FIG. 5, a data acquisition interface 4001 inputs (acquires) PDL data (color printing data).

A drawing unit 4002 interprets the PDL data to draw bitmap data.

A drawn data storage memory 4003 stores printing data created by the drawing unit 4002.

A recording unit 4004 executes printing processing on a recording medium such as a recording sheet on the basis of video signals transmitted to the engine section 1220 from the controller section 1210.

A second drawn data storage memory 4005 stores the printing data until the end of the printing processing.

A residual amount detection unit 4006 detects the residual amount of a color material such as a black material and chromatic color materials.

A data conversion unit 4007 converts color printing data to monochrome printing data.

A method selection unit 4008 is manipulated when a user selects printing control processing that is performed when the residual amount of a color material becomes a predetermined amount or less.

A control unit 4009 performs overall control of the whole image printing apparatus, i.e., the above respective means.

Here, the correspondence relation between the respective components of the image printing apparatus shown in FIG. 5 and the respective components of the image printing apparatus shown in FIG. 2 will be described.

The data acquisition interface 4001 is realized by the external interface 1211.

The drawing unit 4002 and the data conversion unit 4007 are realized as the CPU 1212 loads a control program stored in the ROM 1213 to the RAM 1214 to execute the control program.

The drawn data storage memory 4003 and the second drawn data storage memory 4005 are realized by the RAM 1214 or the external storage unit 1217.

The recording unit 4004 is realized by the recording part 1222, the color material storage and supply part 1223, and the sheet feed and conveyance part 1225.

The residual amount detection unit 4006 is realized by the color material detection part 1224.

The method selection unit 4008 is realized by the display panel part 1232 and the input part 1233 of the manipulation panel section 1230. Specifically, the method selection unit 4008 is realized by switching a control method of the controller section 1210 on the basis of input information according to user input from the display panel part 1232 or the input part 1233.

A control program for carrying out the overall control of the respective means is stored in the ROM 1213. The control unit 4009 loads the control program from the ROM 1213 to the RAM 1214, and executes this program to thereby perform overall control of the whole image printing apparatus, i.e., the above respective means.

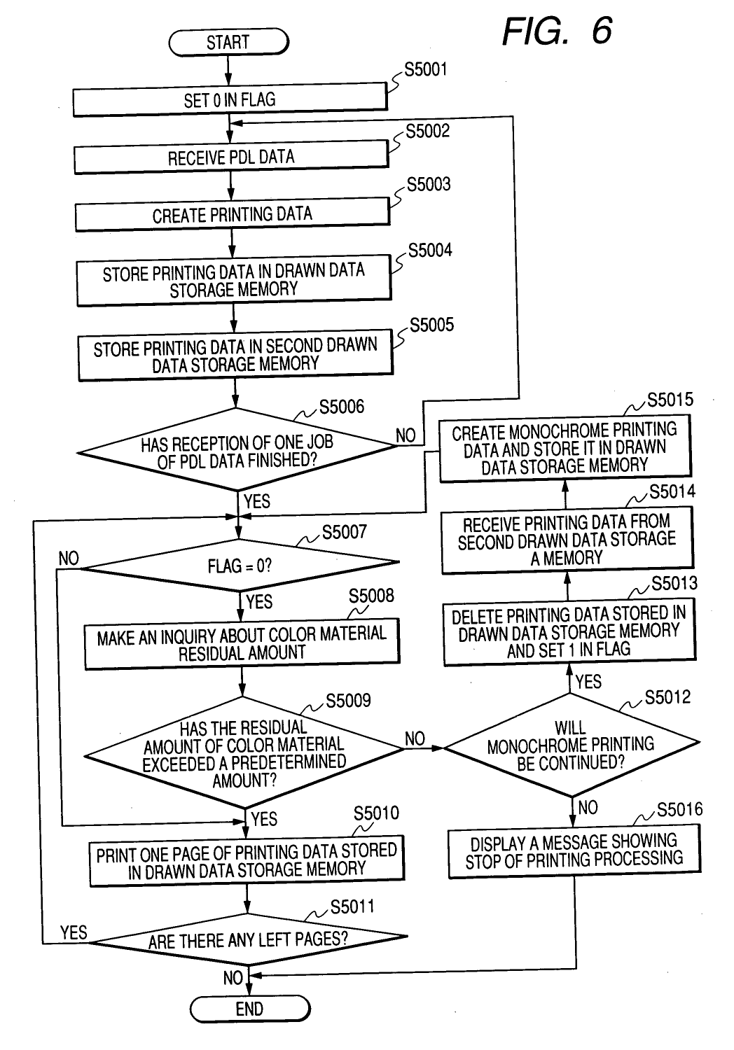

Next, the printing processing operation of the image printing apparatus 1200 configured as above will be described referring to FIG. 6.

FIG. 6 is a flow chart of the operation of the image printing apparatus according to Embodiment 2 of the invention, which shows a form in which the image printing apparatus 1200 acquires color printing data created on the side of the host computer 1100 to execute print.

As shown in FIG. 6, the control unit 4009 sets “0” in a color material residual amount flag before receiving one page of PDL data (S5001), and thereafter receives PDL data transmitted from the host computer 1100 via the data acquisition interface 4001 (S5002). Next, the control unit transfers the received PDL data to the drawing unit 4002, and requests the drawing unit to perform drawing processing of the printing data (S5003).

The drawing unit 4002 that has received the request to perform drawing processing from the control unit 4009 interprets the received PDL data, draws printing data on the basis of the interpreted result, and stores the drawn (created) printing data in the drawn data storage memory 4003 (S5004). Further, the drawing unit stores the drawn (created) printing data in the second drawn data storage memory 4005 (S5005).

The drawing unit 4002 that has finished S5005 in this way notifies the control unit 4009 that, the drawing processing has been finished.

The control unit 4009 that has received the notification that the drawing processing has been finished determines whether or not one page of PDL data has been completely received (S5006). In S5006, if the control unit determines that one page of PDL data has not yet been completely received, it returns to S5002, and repeats the processing of the above-mentioned S5002 to S5006 until one page of PDL data has been completely received.

In S5006, the control unit 4009 that has determined that one page of PDL data has been completely received determines whether or not the color material residual amount flag is “0” (S5007). As a result of this determination, if the color material residual amount flag is “0,” the control unit makes an inquiry to the residual amount detection unit 4006 about the residual amount of a color material (S5008), and then determines whether or not the residual amount of a color material needed for printing exceeds a predetermined amount on the basis of the inquiry result from the residual amount detection unit 4006 (S5009).

In S5009, if the control unit 4009, which has determined that the residual amount of a chromatic color material when the printing data is printable with only a black material or when the printing data also needs chromatic color materials has exceeded a predetermined amount, reads out one page of printing data stored in the printing data storage memory 4003, and transmits the read-out data to the recording unit 4004, the recording unit 4004 executes printing processing on the basis of the one page of printing data received (S5010).

When S5010 has been finished, the control unit 4009 determines whether or not pages to be printed are left (S5011). As a result of this determination, if there are any left pages, the control unit returns to S5007, and repeats the processing of the above-mentioned S5007 to S5011 until any left pages do not exist, while the control unit finishes this processing if there is no left page.

On the other hand, if the control unit determines in S5007 that the color material residual amount flag is “1,” it proceeds to S5010.

Further, the control unit 4009 that has determined in S5009 that the residual amount of a color material is a predetermined amount or less makes an inquiry to the method selection unit 4008 about whether or not monochrome printing will be performed.

Then, the method selection unit 4008 determines whether or not the monochrome printing will be continued, on the basis of information showing a control method set according to input manipulation of the manipulation panel section 1230 by a user (S5012), and sends the determined result back to the control unit 4009 as an inquiry result about the above inquiry.

The control unit 4009 that has received the inquiry result sent back from the method selection unit 4008, if the inquiry result shows that the monochrome printing will be continued, deletes the printing data stored in the printing data storage memory 4003, and updates the color material residual amount flag, in which “0” is set, to “1” (sets “1” in the color material residual amount flag) (S5013).

The control unit 4009 that has finished S5013 requests the data conversion unit 4007 to perform creation processing of monochrome printing data.

The data conversion unit 4007 that has received the request to perform creation processing reads out the printing data (color printing data) from the second drawn data storage memory 4005 (S5014), creates monochrome printing data on the basis of the read-out color printing data, and stores the created monochrome printing data in the drawn data storage memory 4003 (S5010). That is, the data conversion unit 4007 converts the color printing data to monochrome printing data.

Incidentally, the processing of S5015 can be executed, for example, when the residual amount of a color material (that is, one color material of chromatic color materials) of at least one color other than black among color materials of a plurality of colors including black becomes a predetermined amount or less.

When S5015 has been finished, the process proceeds to S5007. In other words, when S5015 has been finished, since the data conversion unit 4007 notifies the control unit 4009 that the creation processing of the monochrome printing data has been finished, the control unit 4009 executes the steps after S5007.

Meanwhile, if the inquiry result sent back from the method selection unit 4008 that has executed S5012 shows that the monochrome printing will not be continued, that is, the inquiry result shows stop of the printing processing, the control unit 4009 causes a message that the printing processing will be stopped to be displayed on the display panel part 1232 of the manipulation panel section 1230 (S5016), and finishes this processing.

In addition, in Embodiment 2, as the printing data to be drawn (created) by the drawing unit 4002, that is, as the color printing data to be stored in the second drawn data storage memory 4005, there are bitmap data drawn by RGB 8-bits, continuous tone printing data such as bitmap data color-converted to CMYK 8-bit data, and halftone printing data gradation-converted to CMYK 1-bit or n-bit data.

Besides, when the residual amount of a color material (that is, one color material of chromatic color materials) of at least one color other than black among color materials of a plurality of colors including black becomes a predetermined amount or less, the continuous tone or halftone printing data stored in the second drawn data storage memory 4005 is converted to printing data (monochrome printing data) that is printable with a color material of black by the data conversion unit 4007.

In addition, in this case, although various image processing method are conceivable as the method of creating the monochrome printing data on the basis of printing data of RGB 8-bit, continuous tone printing data of CMYK 8-bit, or halftone printing data of CMYK 1-bit or n-bit, any of these methods may be used.

Further, in Embodiment 2, in a case in which the printing data is bitmap data drawn by RGB 8-bits or continuous tone printing data such as bitmap data color-converted to CMYK 8-bit data, when the printing data (color printing data) is transmitted to the engine section 1220 to thereby start printing processing, it is necessary to perform color conversion processing or gradation conversion processing, and to transmit video signals to the engine section 1220 while creating halftone printing data.

As described above, according to Embodiment 2, the second drawn data storage memory 4005 stores bitmap printing data on the basis of the PDL data until the end of printing. During color printing, if the residual amount detection unit 4006 has detected that the residual amount of a color material becomes a predetermined amount or less, the data conversion unit 4007 is adapted to draw printing data that is printable with only a black material again on the basis of the bitmap printing data stored in the second drawn data storage memory 4005, and the recording unit 4004 is adapted to execute printing processing on the basis of the printing data that is printable with only the black material. Thus, when the residual amount detection unit has detected that the residual amount of a color material becomes a predetermined amount or less, it is possible to obtain a monochrome printing result in a case in which the stored printing data is RGB 8-bit data or CMYK 8-bit data. Further, in a case in which the stored printing data is CMYK 1-bit data or n-bit data, the second drawn data storage memory 4005 may have a smaller memory capacity than that in a case in which the printing data is RGB 8-bit data or CMYK 8-bit data. It is also possible to obtain a monochrome printing result.

Further, according to Embodiment 2, during printing processing on the printing data based on the PDL data, when the residual amount detection unit has detected that the residual amount of a color material (that is, one color material of chromatic color materials) of at least one color other than black becomes a predetermined amount or less, the continuous tone or halftone printing data stored in the second drawn data storage memory 4005 is converted to printing data that is printable with a color material of black. Thus, when the residual amount of a color material of at least one color other than black among color materials of a plurality of colors including black becomes a predetermined amount or less, a whole image can be monochrome-printed.

As a result, it is possible to obtain a monochrome printing result, and it is also possible to provide a natural monochrome printing result without providing an unnatural image (printing result) where regions exhibiting substantial color reproduction and regions exhibiting no substantial color reproduction are mixed, unlike a related image printing apparatus.

Moreover, according to Embodiment 2, basic data used to draw printing data that is printable with a color material of black, for example, continuous tone data or halftone printing data is stored in the second drawn data storage memory 4005 serving as the external storage unit. Thus, the memory efficiency of a main storage means (for example, the RAM 1214) to perform drawing processing and image processing can be improved, and the printing processing efficiency can be improved. Further, during printing that utilizes the external storage unit, such as memory printing, even if the residual amount of a color material of at least one color other than black becomes a predetermined amount or less, a whole image can be monochrome-printed.

(Embodiment 3)

In Embodiment 2, although the image printing apparatus 1200 receives PDL data transmitted from the host computer 1100 and the controller section 1210 of the image printing apparatus 1200 executes drawing processing of printing data on the basis of the received PDL data, the invention is not limited thereto, but may be executed in the following manner.

That is, the host computer 1100 interprets PDL data and creates printing data on the basis of the interpreted result. As the printing data in this case, there are bitmap data drawn by RGB 8-bits, continuous tone printing data such as bitmap data color-converted to CMYK 8-bit data, or halftone printing data gradation-converted to CMYK 1-bit or n-bit data.

As the image printing apparatus 1200, there is employed an image printing apparatus such as a GDI (Graphics Device Interface) printer that receives printing data created outside, such as in the host computer 1100, instead of the PDL data.

In the image printing apparatus such as the GDI printer, the drawing processing by the drawing unit 4002 does not function. Therefore, it is not necessary to provide the drawing unit 4002.

In addition, when the image printing apparatus such as the GDI printer is used, the host computer 1100 may create printing data utilizing signals output by application programs as they are instead of using the PDL (Page Description Language).

Now, the configuration and operation of the image printing apparatus such as the above-mentioned GDI printer will be described.

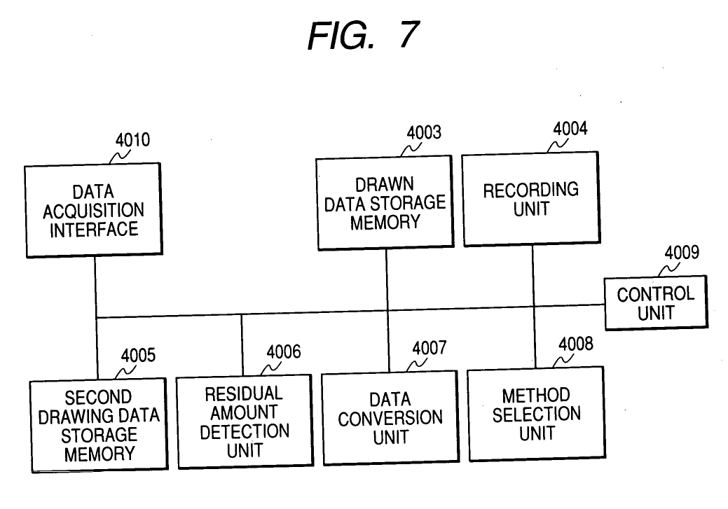

FIG. 7 shows the functional configuration of an image printing apparatus according to Embodiment 3 of the invention.

The image printing apparatus shown in FIG. 7 is different from the image printing apparatus shown in FIG. 5 in that the drawing unit 4002 is not needed, and a data acquisition interface 4010 receives printing data created on the side of the host computer 1100, and is the same as that in FIG. 5 in terms of the other configuration.

In addition, the data acquisition interface 4010 is realized as an interface by the external interface 1211 shown in FIG. 2.

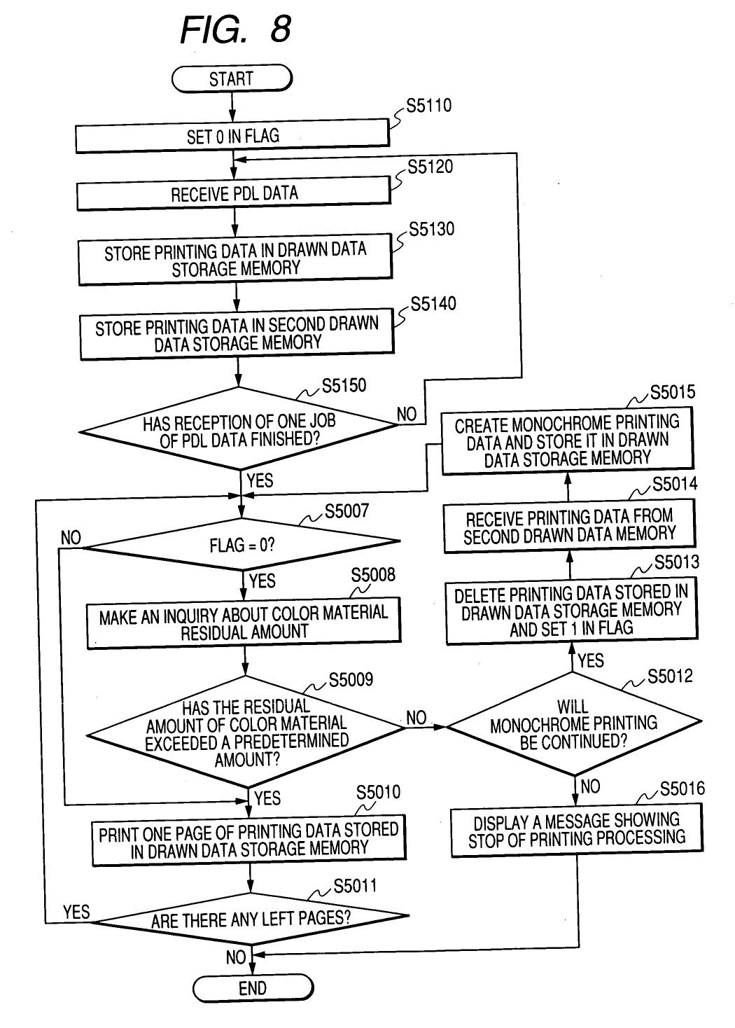

The image printing apparatus configured as above will execute printing processing according to a flow chart of FIG. 8 showing the printing processing operation thereof.

FIG. 8 is a flow chart of the operation of the image printing apparatus according to Embodiment 3 of the invention.

In addition, the processing procedure shown in FIG. 8 has contents obtained by substituting S5001 to S5006 in the processing procedure shown in FIG. 6 with S5110 to S5150.

As shown in FIG. 8, the control unit 4009 sets “0” in a color material residual amount flag before receiving one page of printing data (S5110), and thereafter receives drawn printing data transmitted from the host computer 1100 via the data acquisition interface 4010 (S5120).

Next, the control unit stores the received printing data in the drawn data storage memory 4003 and stores the received printing data in the second drawn data storage memory 4005 (S5140), and further determines whether or not one job of printing data has been completely received (S5150).

In S5150, if the control unit has determined that one job of printing data has not yet been completely received, it returns to S5120.

On the other hand, if the control unit has determined that one job of printing data has been completely received, it proceeds to S5007. Since the processing after Step S5007 is the same as that in the processing procedure shown in FIG. 6, the description thereof is omitted herein.

As described above, according to Embodiment 3, during printing processing on continuous tone or halftone printing data that is created outside, such as in the host computer 1100, when the residual amount detection unit has detected that the residual amount of a color material (that is, one color material of chromatic color materials) of at least one color other than black becomes a predetermined amount or less, the continuous tone or halftone printing data that is created outside and stored in the second drawn data storage memory 4005 is converted to printing data that is printable with a color material of black. Thus, when the residual amount of a color material of at least one color other than black among color materials of a plurality of colors including black becomes a predetermined amount or less, a whole image can be monochrome-printed.

As a result, it is possible to obtain a monochrome printing result, and it is also possible to provide a natural monochrome printing result without providing an unnatural image (printing result) where regions exhibiting substantial color reproduction and regions exhibiting no substantial color reproduction are mixed, unlike a related image printing apparatus.

(Embodiment 4)

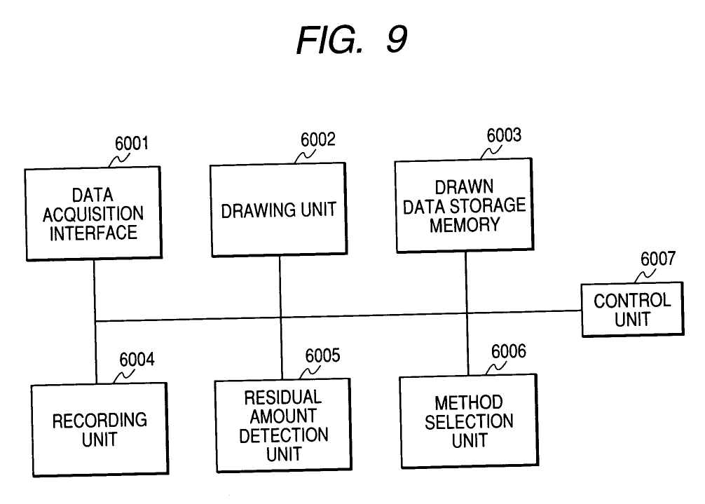

FIG. 9 is a functional block diagram of an image printing apparatus according to Embodiment 4 of the invention.

Since the hardware configuration of the image printing apparatus according to Embodiment 4 is the same as the configuration of the image printing apparatus according to Embodiment 1 shown in FIG. 2, the description thereof is omitted herein.

In FIG. 9, a data acquisition interface 6001 inputs (acquires) PDL data.

A drawing unit 6002 interprets the PDL data to draw bitmap data.

A drawn data storage memory 6003 stores printing data created by the drawing unit 6002.

A recording unit 6004 executes printing processing on a recording medium such as a recording sheet on the basis of video signals transmitted to the engine section from the controller section.

A residual amount detection unit 6005 detects the residual amount of a color material such as a black material and chromatic color materials.

A method selection unit 6006 is manipulated when a user selects printing control processing that is performed when the residual amount of a color material becomes a predetermined amount or less.

A control unit 6007 performs overall control of the whole image printing apparatus, i.e., the above respective means.

Here, the correspondence relation between the respective components of the image printing apparatus shown in FIG. 9 and the respective components of the image printing apparatus shown in FIG. 2 will be described.

The data acquisition interface 6001 is realized by the external interface 1211.

The drawing unit 6002 is realized as the CPU 1212 loads a control program stored in the ROM 1213 to the RAM 1214 to execute the control program.

The drawn data storage memory 6003 is realized by the RAM 1214 or the external storage unit 1217.

The recording unit 6004 is realized by the recording part 1222, the color material storage and supply part 1223, and the sheet feed and conveyance part 1225.

The residual amount detection unit 6005 is realized by the color material detection part 1224. The method selection unit (selection means) 6006 is realized by the display panel part 1232 and the input part 1233 of the manipulation panel section 1230. Specifically, the method selection unit 6006 is realized by switching a control method of the controller section 1210 on the basis of input information according to user input from the display panel part 1232 or the input part 1233.

A control program for carrying out the overall control of the respective means is stored in the ROM 1213. The control unit 6007 loads the control program from the ROM 1213 to the RAM 1214, and executes this program to thereby perform overall control of the whole image printing apparatus, i.e., the above respective means.

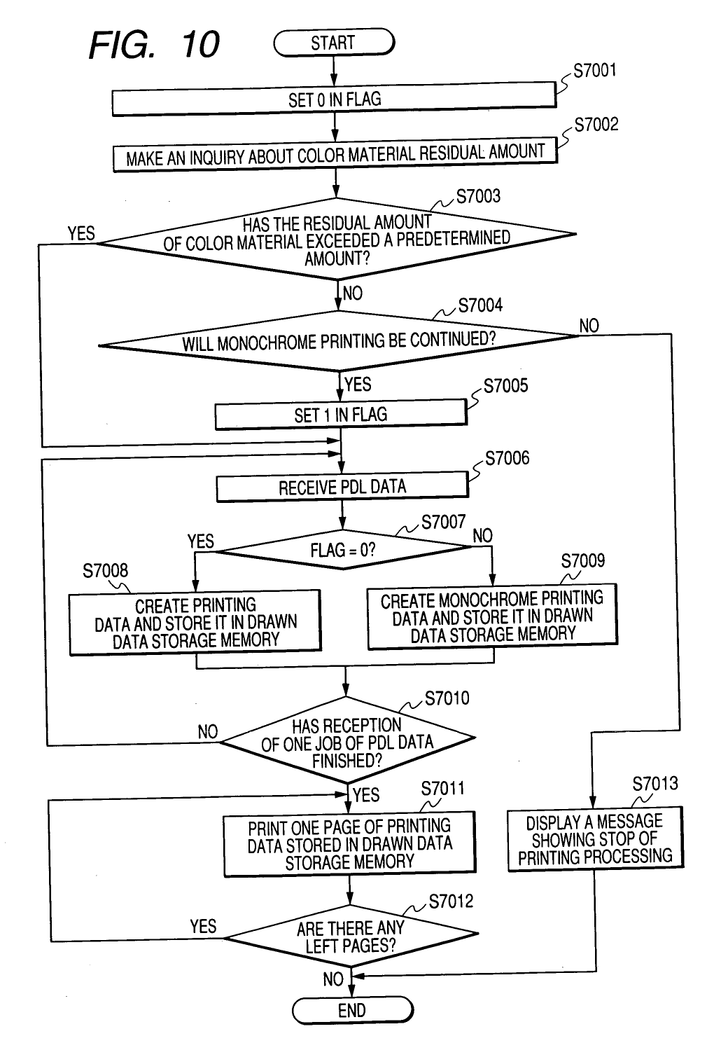

Next, the printing processing operation of the image printing apparatus 1200 configured as above will be described referring to FIG. 10.

FIG. 10 is a flow chart of the operation of the image printing apparatus according to Embodiment 4 of the invention, which illustrates printing processing operation.

As shown in FIG. 10, the control unit 6007 sets “0” in a color material residual amount flag before receiving one page of PDL data (S7001), then make an inquiry to the residual amount detection unit 6005 about the residual amount of a color material (S7002), and then determines whether or not the residual amount of a color material needed for printing exceeds a predetermined amount on the basis of the inquiry result from the residual amount detection unit 6005 (S7003).

In S7003, if the control unit 6007 that has determined that the residual amount of a color material is a predetermined amount or less asks the method selection unit 6006 whether to perform the monochrome printing or not, the method selection unit 6006 determines whether or not the monochrome printing will be continued, on the basis of information showing a control method set according to input manipulation of the manipulation panel section 1230 by a user (S7004), and sends the determined result back to the control unit 6007 as an inquiry result about the above inquiry.

The control unit 6007 that has received the inquiry result sent back from the method selection unit 6006 that has executed S7004, if the inquiry result shows that the monochrome printing will be continued, updates the color material residual amount flag, in which “0” is set, to “1” (sets “1” in the color material residual amount flag) (S7005), and receives the PDL data transmitted from the host computer 1100 via the data acquisition interface 6001 (S7006).

In addition, if the control unit has determined in S7003 that the residual amount of a color material exceeds a predetermined amount, it proceeds to S7006.

On the other hand, the control unit 6007 that has finished S7006 determines whether or not the color material residual amount flag is “0” (S7007). If the control unit has determined that the color material residual amount flag is “0,” the control unit transfers the received PDL data to the drawing unit 6002, and requests the drawing unit to perform drawing processing of the printing data.

The drawing unit 6002 that has received the request to perform drawing processing from the control unit 6007 interprets the received PDL data, draws printing data on the basis of the interpreted result, and stores the drawn (created) printing data in the drawn data storage memory 6003 (S7008). The drawing unit 6002 that has finished this processing notifies the control unit 6007 that the drawing processing has been finished.

On the other hand, in S7007, the control unit 6007 that has determined that the color material residual amount flag is not “0” but “1” transfers the received PDL data to the drawing unit 6002, and requests the drawing unit to perform monochrome drawing processing.

The drawing unit 6002 that has received the request to perform monochrome drawing processing from the control unit 6007 in this manner interprets the received PDL data. If the interpreted result is color data, the drawing unit draws printing data that is printable with a black material on the basis of the PDL data (color data), and stores the drawn (created) printing data (monochrome printing data) in the drawn data storage memory 6003 (S7009). The drawing unit 6002 that has finished this processing notifies the control unit 6007 that the drawing processing has been finished.

Incidentally, the processing of S7009 can be executed, for example, when the residual amount of a color material (that is, one color material of chromatic color materials) of at least one color other than black among color materials of a plurality of colors including black becomes a predetermined amount or less.

The control unit 6007 that has received the notification that the drawing processing has been finished from the drawing unit 6002 that has finished S7008 or S7009 determines whether or not one page of PDL data has been completely received (S7010).

In S7010, if the control unit determines that one job of PDL data has not yet been completely received, it returns to S7006, and repeats the processing of the above-mentioned S7006 to S7010 until one job of PDL data has been completely received.

In S7010, if the control unit 6007 that has determined that one job of PDL data has been completely received reads out one page of printing data stored in the drawn data storage memory 6003, and transmits the read-out data to the recording unit 6004, the recording unit 6004 executes printing processing on the basis of the one page of printing data received (S7011).

When S7011 has been finished, the control unit 6007 determines whether or not pages to be printed are left (S7012). As a result of this determination, if there are any left pages, the control unit returns to S7011, and repeats the processing of the above-mentioned S7011 and S7012 until any left pages do not exist, while the control unit finishes this processing if there is no left page.

Meanwhile, if the inquiry result sent back from the method selection unit 6006 that has executed S7004 shows that the monochrome printing will not be continued, that is, the inquiry result shows stop of the printing processing, the control unit 6007 causes a message that the printing processing will be stopped to be displayed on the display panel part 1232 of the manipulation panel section 1230 (S7013), and finishes this processing.

(Embodiment 5)

In Embodiment 4, although the image printing apparatus 1200 receives PDL data transmitted from the host computer 1100 and the controller section 1210 of the image printing apparatus 1200 executes drawing processing of printing data on the basis of the received PDL data, the invention is not limited thereto, but may be executed in the following manner.

That is, the host computer 1100 interprets PDL data and creates printing data on the basis of the interpreted result. As the printing data (color printing data) in this case, there are bitmap data drawn by RGB 8-bits, continuous tone printing data such as bitmap data color-converted to CMYK 8-bit data, or halftone printing data gradation-converted to CMYK 1-bit or n-bit data.

In addition, when the image printing apparatus such as the GDI printer is used, the host computer 1100 may create printing data utilizing signals output by application programs as they are instead of using the PDL.

As the image printing apparatus 1200, there is employed an image printing apparatus such as a GDI printer that receives printing data created outside, such as in the host computer 1100, instead of the PDL data.

In the image printing apparatus such as the GDI printer, a storage memory having the same function as the second drawn data storage memory 4005 of Embodiment 2, and a data conversion unit having the same function as the data conversion unit 4007 of Embodiment 2 are added. Also, the drawing processing by the drawing unit 4002 does not function. Therefore, it is not necessary to provide the drawing unit 4002.

Further, in a case in which the printing data is bitmap data drawn by RGB 8-bits or continuous tone printing data such as bitmap data color-converted to CMYK 8-bit data, when the printing data (color printing data) is transmitted to the engine section 1220 to thereby start printing processing, it is necessary to perform color conversion processing or gradation conversion processing, and to transmit video signals to the engine section 1220 while creating halftone printing data.

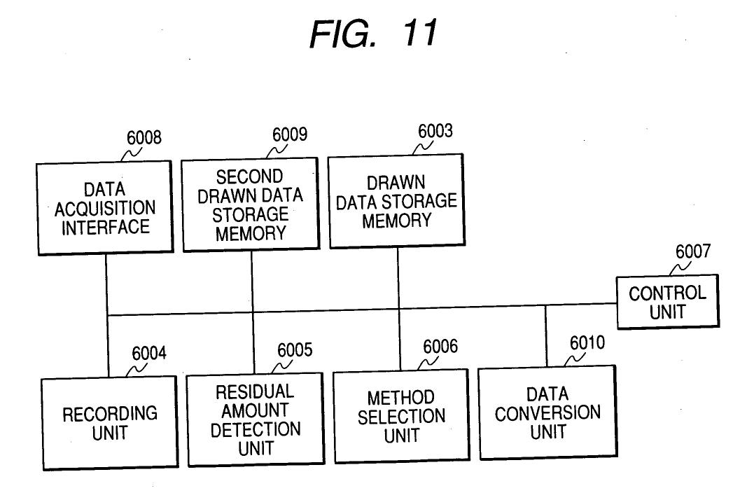

FIG. 11 shows the functional configuration of an image printing apparatus according to Embodiment 5 of the invention.

The image printing apparatus shown in FIG. 11 is different from the image printing apparatus shown in FIG. 9 in that the drawing unit 6002 is not needed, and a data acquisition interface 6008 receives printing data created on the side of the host computer 1100. Also, the image printing apparatus has a second drawn data storage memory 6009 and a data conversion unit 6010 that play the same roles as those in shown in FIG. 5 of Embodiment 2. The other configuration of the image printing apparatus is the same as that in FIG. 9.

In addition, the data acquisition interface 6008 is realized as an interface by the external interface 1211 shown in FIG. 2.

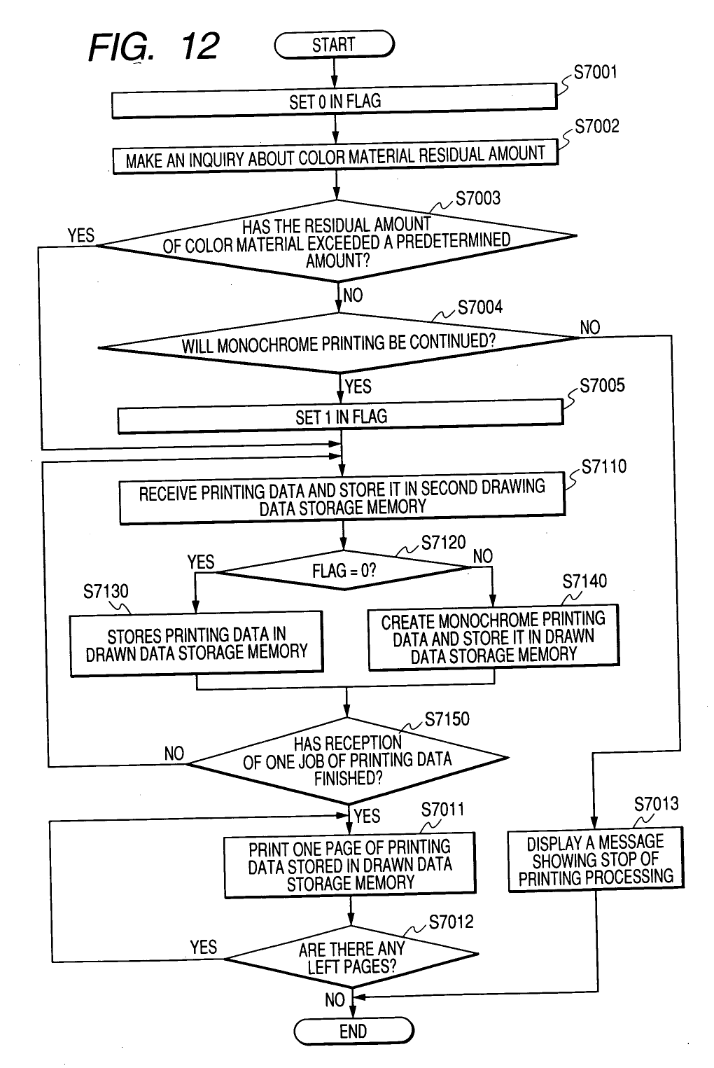

Now, the operation of the image printing apparatus such as the above-mentioned GDI printer will be described referring to FIG. 12.

FIG. 12 is a flow chart of the operation of the image printing apparatus according to Embodiment 5 of the invention, which illustrates printing processing operation.

The processing procedure shown in FIG. 12 has contents obtained by substituting S7006 to S7011 in the processing procedure shown in FIG. 10 with S7110 to S7150. Thus, only the processing of S7110 to S7150 will be described herein.

As shown in FIG. 12, the control unit 6007 that has finished S7005 receives printing data transmitted from the host computer 1100 via the data acquisition interface 6008, and stores the printing data in the second drawn data storage memory 6009 (S7110), and thereafter determines whether or not the color material residual amount flag is “0” (S7120).

The control unit 6007 that has determined in S7120 that the color material residual amount flag is “0” reads out the printing data stored in the second drawn data storage memory 6009 to store the printing data in the drawn data storage memory 6003 (S7130).

On the other hand, the control unit 6007 that has determined in S7120 that the color material residual amount flag is “1” requests the data conversion unit 6010 to perform creation processing of monochrome printing data. The data conversion unit 6010 that has received the request to perform creation processing reads out the printing data (color printing data) from the second drawn data storage memory 6009, creates monochrome printing data on the basis of the read-out color printing data, and stores the created monochrome printing data in the drawn data storage memory 6003 (S7140). That is, the color printing data is converted to monochrome printing data.

When S7130 or S7140 has been finished, the control unit 6007 determines whether or not one job of printing data has been completely received (S7150).

In S7150, if the control unit has determined that one job of printing data has not yet been completely received, it returns to S7110. On the other hand, if the control unit has determined that one job of printing data has been completely received, it proceeds to S7012.

Meanwhile, in order to promote the efficiency of printing processing and effectively utilize memory resources, the above-described Embodiment 1 to 5 may be performed like the contents described in the following (1) to (3):

(1) In order to efficiently use the memory capacity of the RAM 1214, the printing data is subjected to compression/decompression processing.

(2) In order to accelerate all or some of image processing such as color conversion or gradation conversion that is performed in the compression/decompression processing or drawing processing, LSIs (Large Integrated Circuit) are used in place of the CPU 1212.

(3) The bitmap data drawn by RGB 8-bits, continuous tone printing data such as bitmap data color-converted to CMYK 8-bit data, or halftone printing data gradation-converted to CMYK 1-bit or n-bit data is compressed and stored in the printing data storage memory.

(Embodiment 6)

Embodiments 6 and 7 will be described in more detail from the viewpoint of processing the halftone data in Embodiments 1 to 5.

When color halftone data is converted to monochrome halftone data or vice versa, heretofore, the color halftone data or the monochrome halftone data is first converted to color continuous tone data or monochrome continuous tone data, and then monochrome halftone data or color halftone data is created.

Time is additionally taken as much as the time required for image-region separating processing or filtering processing that converts the color halftone data or the monochrome halftone data to color continuous tone data or monochrome continuous data at this intermediate stage. Further, storage means enough to perform the processing at this intermediate stage are additionally required. Moreover, if erroneous discrimination of image regions occurs in the processing at this intermediate stage, blurring or unnatural edge reinforcement of character or line images, moire in the gradation conversion resulting from insufficient dot removal, or the like occur.

In short, since realization of high speed and high image quality by virtue of memory saving is required in this type of image processing device, it was a related problem to realize an image processing device capable of omitting the processing at the above intermediate stage, and capable of performing direct conversion of the color halftone data to monochrome halftone data or its reverse conversion.

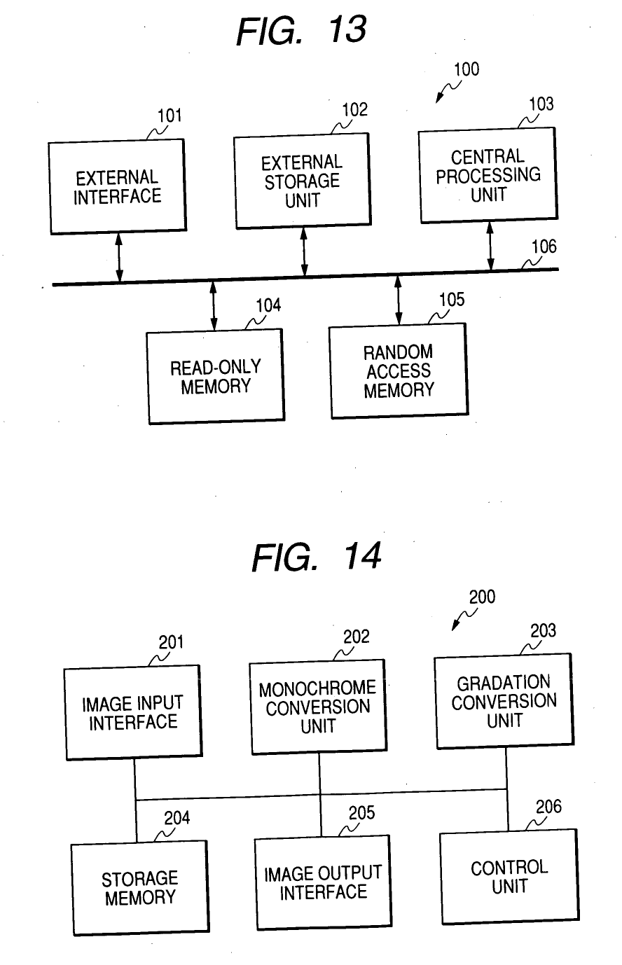

FIG. 13 shows the hardware configuration of an image processing device according to Embodiment 6 of the invention.

In FIG. 13, the image processing device 100 includes an external interface 101, an external storage unit 102, a CPU 103, a ROM 104, and a RAM 105. These respective components are bus-coupled to one another by a database 106.

Although the external interface 101 is an interface that performs input of halftone data as an object to be processed and output of halftone data as a processing result by performing data transmission/reception with the host computer, according to aspects to which the image processing device is applied, the external interface may also include interfaces that perform, for example, data transmission/reception with the engine section to record printing data on a sheet or data transmission/reception with a display panel to perform device setting according to device conditions, information display or user manipulation. In addition, when the image processing device is mounted on an image printing apparatus, an image forming apparatus, or an image copying apparatus, these apparatuses will have most of the functions of the external interface 101.

The external storage unit 102 is a storage unit that performs temporary storage of halftone data as a processing object input by the external interface 101 and halftone data as a processing result transferred to the external interface 101. For example, hard disc drives (HDDs), CD-ROMs, CD-RWs, DVD-RWs, DVD-RAMs, flash memories, and the like are used as the external storage unit. The external storage unit may also include control programs.

Control programs to be executed by the CPU 103 are stored in the ROM 104. However, as described above, when the image processing device is mounted on an image printing apparatus, an image forming apparatus, or an image copying apparatus, font information, information on the printing apparatus, or the like may be stored in the ROM.

The RAM 105 is used when the CPU 103 performs image processing. However, as described above, in a case in which the image processing device is mounted on an image printing apparatus, an image forming apparatus, or an image copying apparatus, the RAM may be used for storing various kinds of data including printing data transmitted from the host computer.

The CPU 103 first controls the external interface 101 via the database 106 to first store halftone data as a processing object input by the external interface 101 in the external storage unit 102. Then, during image processing, the CPU fetches a control program stored in the ROM 104 to load it on the ROM 105. Based on this, the CPU transmits the halftone data as a processing object from the external storage unit 102 via the database 106 to the RAM 105, executes image processing while retaining intermediate data in the image processing, under memory management and job management needed for a series of image processing steps, using the RAM 105, and then stores a final processing result in the external storage unit 102. Thereafter, at a proper time, the CPU causes the final processing result to be delivered to the external interface 101 via the database 106 from the external storage unit 102.

In addition, in a case in which the image processing device is mounted on an image printing apparatus, an image forming apparatus, or an image copying apparatus, the CPU 103 may also perform control of the whole apparatus such as operation of the engine section and panel display onto a display panel, and image processing such as interpretation of PDL data, drawing, color conversion or gradation conversion suitable for printing apparatuses, and creates printing data (bitmap data).

First, referring to FIGS. 14 to 20, the configuration and operation according to Embodiment 6 in a case in which color halftone data is directly converted to monochrome halftone data will be described.

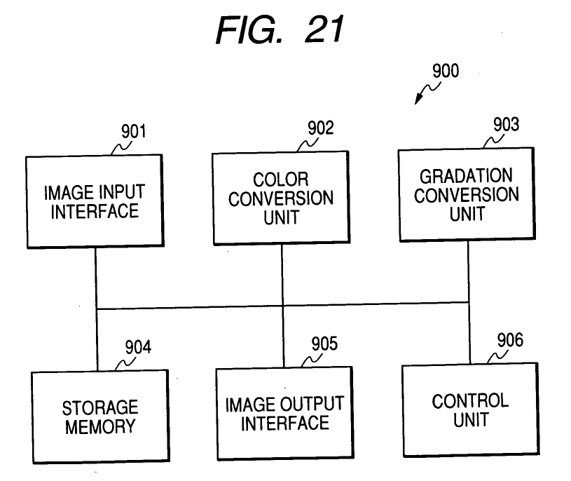

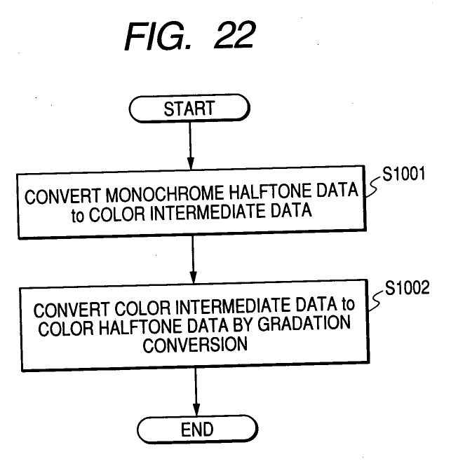

In addition, on the contrary, the configuration and operation in a case in which monochrome halftone data is directly converted to color halftone data will be described later as Embodiment 7 (FIGS. 21 and 22).

FIG. 14 shows the functional configuration of the image processing device according to Embodiment 6 of the invention, and also shows the functional configuration of the image processing device that directly converts color halftone data to monochrome halftone data, which is realized by the configuration shown in FIG. 13.

The image processing device 200 shown in FIG. 14 includes an image input interface 201 that inputs color halftone data as a processing object, a monochrome conversion unit (first conversion unit) 202 that converts the color halftone data to monochrome intermediate data, a gradation conversion unit (second conversion unit) 203 that converts the converted monochrome intermediate data to monochrome halftone data, a storage memory 204 that stores image data in processing or control programs, an image output interface 205 that outputs the converted monochrome halftone data, and a control unit 206 that controls the operation of these respective means.

Now, the correspondence relation with the configuration shown in FIG. 1 will be described. The image input interface 201 and the image output interface 205 are realized by the external interface 101.

The storage memory 204 is realized by the external storage unit 102 and the RAM 105.

The monochrome conversion unit 202, the gradation conversion unit 203, and the control unit 206 that controls the operation of the respective means are realized by the CPU 103 that loads a control program stored in the ROM 104 to the RAM 105 and execute the control program. However, some of these units may be realized by LSIs.

Hereinafter, the operation of the image processing device will be described.

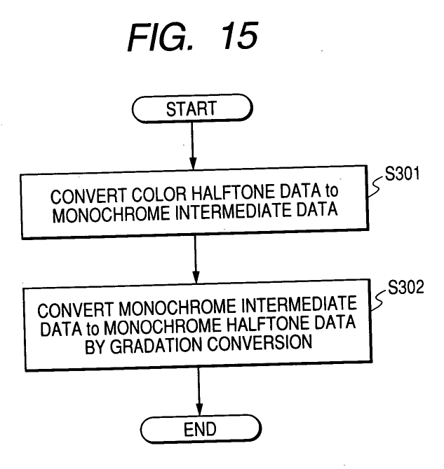

FIG. 15 is a flow chart of the operation of the image processing device shown in FIG. 14.

As shown in FIG. 15, the conversion processing according to Embodiment 6 is completed by two kinds of processing including monochrome conversion processing (S301) and gradation conversion processing (S302).

In the first step S301, the following processing is performed. That is, the monochrome conversion unit 202 converts the color halftone data, which has been stored in advance in the storage memory 204 by the image input interface 201, to monochrome intermediate data, and stores the converted monochrome intermediate data in the storage memory 204.

In the second step S302, the following processing is performed. That is, the gradation conversion unit 203 converts the monochrome intermediate data, which has been stored in the storage memory 204 by the monochrome conversion unit 202, to monochrome halftone data, and stores the converted monochrome halftone data in the storage memory 204. The monochrome halftone data that is the converted data stored in the storage memory 204 in this way is output to the outside at a proper time by the image output interface 205.

Next, the contents of the monochrome conversion processing (S301) and the gradation conversion processing (S302) will be described specifically.

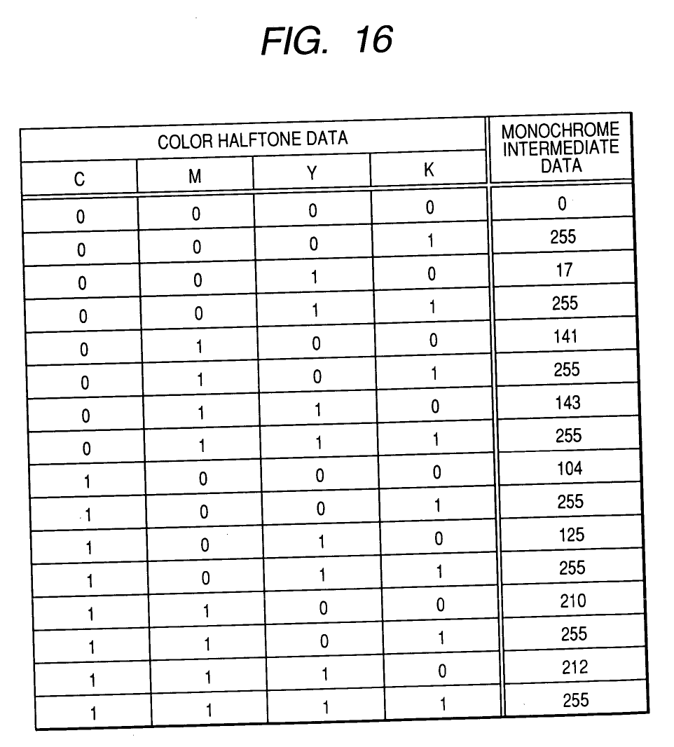

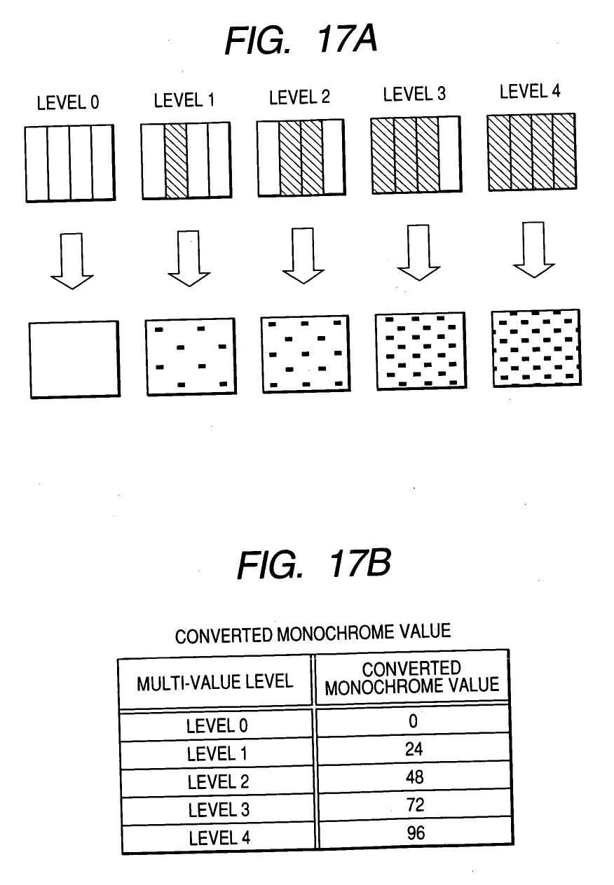

In the monochrome conversion processing (S301), color halftone data is converted to monochrome intermediate data using, for example, a method shown in FIG. 16 in a case in which input data is binary data, and for example, a method shown in FIG. 17 in a case in which input data is multi-value data (N-value: N≧3).

FIG. 16 shows an example of a lookup table to be used in the monochrome conversion processing shown in FIG. 15 in a case in which input data is binary color halftone data.

FIG. 17 is an explanatory view of the operation in monochrome conversion processing shown in FIG. 15 in a case that input data is multi-value (N-value) color halftone data.

For example, in a case in which input data is binary color halftone data consisting of 4 planes of C (cyan), M (magenta), Y (yellow), and K (black), one pixel of each plane consists of 1-bit data of “0” and “1”. Thus, one pixel in four planes becomes 4-bit data. That is, sixteen pixel-value patterns are conceivable.

Accordingly, for conversion from CMYK 4-bit data to monochrome intermediate data, for example, a method that performs using a lookup table, as shown in FIG. 16, in which monochrome density information corresponding to the sixteen pixel-value patterns is stored is conceivable. As shown in FIG. 16, 8-bit data within a range of 0 to 255 is conceivable as the monochrome intermediate data.

Further, in a case in which color conversion from RGB to CMYK is realized by linear transformation, such as correction, and UCR rate is fixed, a method of calculating monochrome density information using mathematical expressions and creating monochrome intermediate data is also conceivable. Moreover, even in a case in which input data is color halftone data consisting of other color spaces of RGB, etc., conversion to monochrome intermediate data can be realized by conversion using lookup tables or conversion using mathematical expressions.

On the other hand, in a case in which input data is multi-value (N-value: N≧3) halftone data, the monochrome conversion unit 202 calculates pixel values of monochrome intermediate data from the multi-value level and color material density of an object pixel. Generally, in a laser printer, the gradation of a printed material is realized by controlling the width of pulses that radiate a laser beam according to multi-value (N-value) levels. In an inkjet printer, the gradation of a printed material is realized by using an ink having a different density according to multi-value (N-value) levels or controlling the amount of ink to be jetted.

Here, referring to FIG. 17, a case in which input data is quinary color halftone data consisting of four planes of CMYK and printing is executed in a laser printer will be described for example.

FIG. 17A is a schematic view of multi-value levels, color material area ratio, and monochrome conversion in a case in which one pixel of the C plane is modulated to 5 values by pulse-width modulation, and FIG. 17B shows an example of converted monochrome values.

In FIG. 17A, no color material is fixed at Level 0, and a color material is fixed on ¼ of a pixel at Level 1, on ½ of the pixel at Level 2, on ¾ of the pixel at Level 3, and on the whole pixel at Level 4. Accordingly, the level of a pixel when converted to monochrome intermediate data is calculated from the area ratio of a color material to be fixed for every color material density and level of C plane.

For example, if input data is multi-value (quinary) halftone data, the color material solid density of C plane is 0.6, and the color material solid density of K plane is 1.6, the converted values of the monochrome intermediate data are as shown in FIG. 17B.

FIG. 17B shows an example when monochrome intermediate data is defined within a range of 0 to 255. For example, since the area ratio is 1/2 at Level 2, a converted value “48” to monochrome intermediate data is calculated by the following expression:
255×(Area ratio)×(C plane solid density)/(K plane solid density)

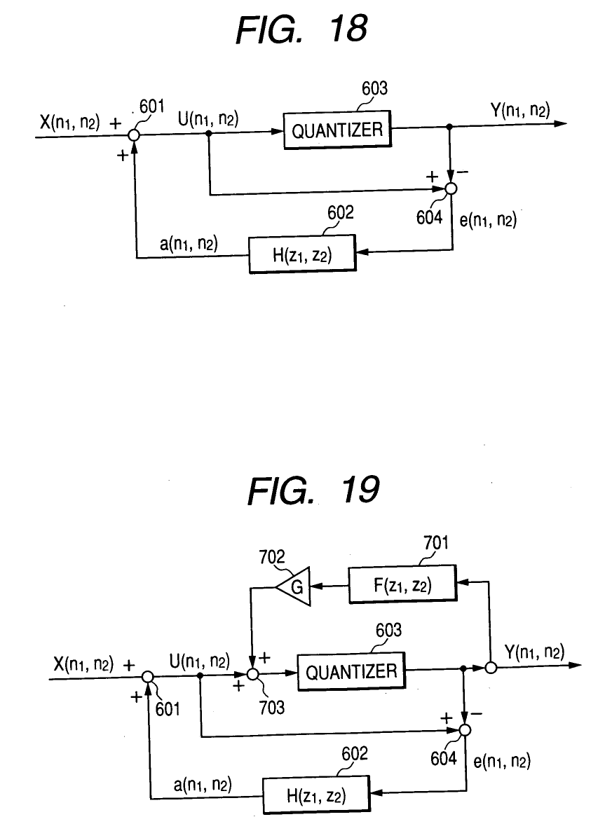

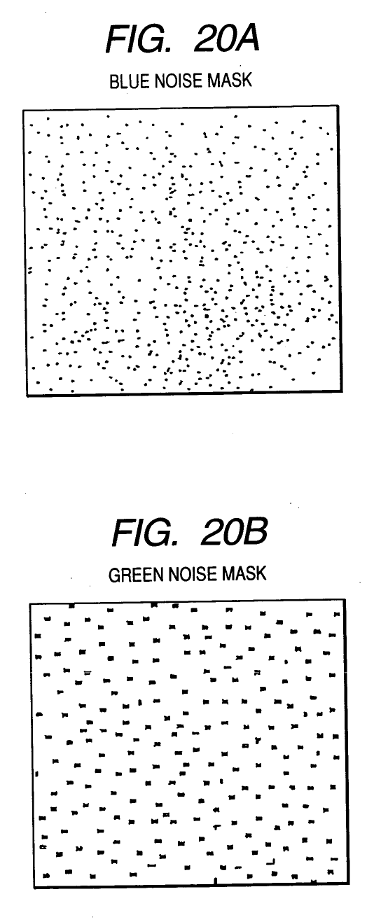

Further, in the gradation conversion processing (S302), for example, monochrome intermediate data is converted to monochrome halftone data by any of an error diffusion method (FIG. 18), a green noise error diffusion method (FIG. 19), a blue noise mask method, and a green noise mask method (FIG. 20). Hereinafter the description thereof will be made in this order.

In the error diffusion method shown in FIG. 18, input data (n1, n2) is added by an adder 601 to quantization noise a(n1, n2) output by a linear filter 602. Most of the addition data U(n1, n2) is quantized by a quantizer 603 and obtained as output values Y(n1, n2). In this process, some of the addition data U(n1, n2) and some of the output values Y(n1, n2) are subtracted by a subtracter 604 and input to the linear filter 602 as quantization errors e(n1, n2). The linear filter 602 repeatedly diffuses the quantization errors e(n1, n2) to provide these to the adder 601, whereby gradation modulation characteristics are determined.

If a quantization threshold in the quantizer 603 is defined as Th, the output values Y(n1, n2) are expressed by the following Expression 1. Here, in order to add processing such as noise reduction and edge reinforcement, which are specific to the error diffusion method, the quantization may be performed by changing the quantization threshold Th according to specific rules.

$$\begin{matrix}Y ( n 1 , n 2 ) = 1 ( if U ( n 1 , n 2 ) \geq Th ) , or \\ = 0 ( if U ( n 1 , n 2 ) < Th )\end{matrix} \qquad ( Expression 1 )$$

Next, in the green noise error diffusion method shown in FIG. 19, the configuration shown in FIG. 18 is provided with a feedback system consisting of a linear filter 701 that determines the shape of output dots using some of the output values Y(n1, n2) of the quantizer 603, an integrator 702 that integrates factors, which determine the size of the output dots, to the output values of the linear filter 701, and an adder 703 that adds the output of the integrator 702 to the addition data U(n1, n2) output by the adder 601 and uses the result as the input of the quantizer 603.

In this case, since past output values are fed back to the quantizer 603, the output values Y(n1, n2) are expressed by the following Expression 2.

$$Y ( n 1 , n 2 ) = 1 ( if U ( n 1 , n 2 ) + G \cdot F * Y ( n 1 , n 2 ) \geq Th ) , \\ or \\ = 0 ( if U ( n 1 , n 2 ) < Th ) \qquad ( Expression 2 )$$

Next, in FIG. 20, an example resulting from performing gradation conversion using a blue mask method is shown in FIG. 20A, and an example resulting from performing gradation conversion using a green mask method is shown in FIG. 20B.

The blue noise mask method or the green noise mask method is a gradation conversion method that compares input data with a threshold value at the same offset position within a mask and performs binarizing on the basis of results of largeness and smallness, and is the same as a general dither method in terms of its principles. The blue noise mask has features that low-frequency components are few, and a number of spectral peaks exist in a high-frequency range. Further, the blue noise mask has features that low-frequency components or high-frequency components are few and a number of spectral peaks exist in an intermediate spectral range.

As described above, according to Embodiment 6, color halftone data is directly converted to monochrome intermediate data, and the converted monochrome intermediate data is subjected to gradation conversion having random components, such as the error diffusion method, the green noise error diffusion method, the green noise mask method, and the blue noise mask method so that monochrome pseudo-conversion halftone data can be obtained, which makes image-region separating processing or filtering processing unnecessary. Thus, it is possible to create monochrome halftone data with no blurring or unnatural edge reinforcement of character or line images, and with no interference with a halftone method of input data.

Accordingly, monochrome halftone data can be obtained with memory saving, high speed and high image quality from the color halftone data.

In this case, in the conversion of color halftone data to monochrome intermediate data, even if input data is not binary halftone data but multi-value (N-value) halftone data, pixel values of the monochrome intermediate data can be calculated from the multi-value levels of object pixels and color material densities. Thus, the multi-value (N-value) color halftone data can be converted to monochrome intermediate data with high image quality.

Further, in the conversion of the converted monochrome intermediate data to the monochrome halftone data, although (1) the error diffusion method may be basically used, (2) when the green noise error diffusion method is used, the number of isolated dots can be reduced as compared to the error diffusion method; (3) when the green noise mask method is used, monochrome halftone data with no interference with the halftone method of input data can be created at higher speed as compared to the error diffusion method; and (4) when the blue noise mask method is used, the number of isolated dots can be reduced as compared to the blue noise mask method. In the case of (2) and (4), even in a printer having inferior dot reproduction, monochrome halftone data that is printable with high image quality can be obtained from the color halftone data.

(Embodiment 7)

FIG. 21 shows the functional configuration of an image processing device according to Embodiment 7 of the invention, and shows as Embodiment 7 an image processing device that directly converts monochrome halftone data to color halftone data, which is realized by the hardware configuration shown in FIG. 13.

The image processing device 900 shown in FIG. 21 includes an image input interface 901 that inputs monochrome halftone data as a processing object, a color conversion unit 902 that converts the monochrome halftone data to color intermediate data, a gradation conversion unit 903 that converts the converted color intermediate data to color halftone data, a storage memory 904 that stores image data in processing or control programs, an image output interface 905 that outputs the converted color halftone data, and a control unit 906 that controls the operation of the respective means.

Here, the correspondence relation with the configuration shown in FIG. 13 will be described.

The image input interface 901 and the image output interface 905 are realized by the external interface 101.

The storage memory 904 is realized by the external storage unit 102 and the RAM 105.

The color conversion unit 902, the gradation conversion unit 903, and the control unit 906 that controls the operation of the respective means are realized by the CPU 103 that loads a control program stored in the ROM 104 to the RAM 105 and execute the control program. However, some of these units may be realized by LSIs.

Hereinafter, the operation of the image processing device will be described.

FIG. 22 is a flow chart of the operation of the image processing device shown in FIG. 21.

As shown in FIG. 22, the conversion processing according to Embodiment 7 is completed by two kinds of processing including color conversion processing (S1001) and gradation conversion processing (S1002).

In the first step S1001, the following processing is performed. That is, the color conversion unit 902 converts the monochrome halftone data, which has been stored in advance in the storage memory 904 by the image input interface 901, to color intermediate data, and stores the converted color intermediate data in the storage memory 904.

In the second step S1002, the following processing is performed. That is, the gradation conversion unit 903 converts the color intermediate data, which has been stored in the storage memory 904 by the color conversion unit 902, to color halftone data, and stores the converted color halftone data in the storage memory 904. The color halftone data stored in the storage memory 904 in this way is output to the outside at a proper time by the image output interface 905.

Next, the contents of the color conversion processing (S1001) and the gradation conversion processing (S1002) will be described specifically.

In the color conversion processing (S1001), since input data is monochrome halftone data, one pixel consists of 1-bit data of “0” and “1.” On the other hand, in a case in which output data is color intermediate data consisting of 4 planes of CMYK, it is conceivable that each plane consists of 8-bit data within a range of 0 to 255.

In this case, with respect to a pixel whose monochrome halftone data as input data is “0,” color intermediate data as output data also becomes “0” with each plane. On the other hand, with respect to a pixel whose monochrome halftone data as input data is “1,” it is necessary to reproduce monochrome colors by three colors of CMY in color intermediate data as output data.

Therefore, for example, C plane is converted to 163, M plane is converted to 133, Y plane is converted to 130, and Y plane is converted to 0. Since it is necessary to reproduce the same colors as monochrome halftone data by three colors, it is necessary to determine the converted values on the basis of color material densities. Further, since the conversion can be performed at a time, it can be executed by conversion tables. Moreover, similarly, even in a case in which output data is color pseudo-halftone data consisting of other color spaces of RGB, etc., conversion to color intermediate data can be realized by conversion tables.

Next, in the gradation conversion processing (S1002), the gradation conversion methods having random components, such as the error diffusion method, the green noise error diffusion method, the green noise mask method, and the blue noise mask method, which are described in Embodiment 6, are similarly applied.

As described above, according to Embodiment 7, monochrome halftone data is directly converted to color intermediate data, and the converted color intermediate data is subjected to gradation conversion having random components, such as the error diffusion method, the green noise error diffusion method, the green noise mask method, and the blue noise mask method so that color pseudo-conversion halftone data can be obtained, which makes image-region separating processing or filtering processing unnecessary. Thus, it is possible to create color halftone data with no blurring or unnatural edge reinforcement of character or line images, and with no interference with an halftone method of input data. Accordingly, color halftone data can be obtained with memory saving, high speed and high image quality from the color halftone data.

In this case, in the conversion of monochrome halftone data to color intermediate data, even if input data is not binary halftone data but multi-value (N-value) halftone data, pixel values of the color intermediate data can be calculated from the multi-value levels of object pixels and color material densities. Thus, the multi-value (N-value) monochrome halftone data can be converted to color intermediate data with high image quality.

Further, in the conversion of the converted color intermediate data to the color halftone data, although (1) the error diffusion method may be basically used, (2) when the green noise error diffusion method is used, the number of isolated dots can be reduced as compared to the error diffusion method; (3) when the green noise mask method is used, color halftone data with no interference with the halftone method of input data can be created at higher speed as compared to the error diffusion method; and (4) when the blue noise mask method is used, the number of isolated dots can be reduced as compared to the blue noise mask method. In the case of (2) and (4), even in a printer having inferior dot reproduction, color halftone data that is printable with high image quality can be obtained from the color halftone data.

By using the image processing device illustrated in Embodiment 6 as a part of an image printing apparatus, an image forming apparatus, or an image copying apparatus, when the residual amount of a chromatic color material is a predetermined amount or less, halftone data (printing data) of a stored color material can be converted to halftone data (printing data) that is printable with a monochrome material. Thus, a user can automatically obtain monochrome printing results with little memory capacity.

By using the image processing device illustrated in Embodiment 7 as a part of an image printing apparatus, an image forming apparatus, or an image copying apparatus, when the amount of a monochrome material is a predetermined amount or less, halftone data (printing data) of a stored monochrome material can be converted to halftone data that is printable with chromatic color materials. Thus, a user can automatically obtain color printing results with little memory capacity.

In addition, when each image processing device illustrated in Embodiments 6 and 7 is used as a part of an image printing apparatus, an image forming apparatus, or an image copying apparatus, as described above, a separate interface (external interface 101) does not exist in the image processing device. Thus, the data stored in the RAM directly becomes input/output data. Further, in order to efficiently use the capacity of the RAM, data may be subjected to compression/decompression processing. It is also conceivable that LSIs (ASICs) are used in order to perform all or some of compression/decompression processing or image processing at high speed. Moreover, it is needless to say that input/output data may be compressed and stored.

This application is based upon and claims the benefit of priority of Japanese Patent Applications No. 2005-050433 filed on Feb. 25, 2005 and 2005-237174 filed on Aug. 18, 2005, the contents of which are incorporated herein by reference in its entirety.

1. An image printing apparatus having color materials of a plurality of colors and performing color printing using the plurality of color materials, the apparatus comprising:
a data acquisition interface which acquires color printing data;
an instruction storage memory which stores a monochrome printing instruction;
a drawing unit which draws the color printing data acquired by the data acquisition interface as printing data being printable with a monochrome material when a monochrome printing instruction is stored in the instruction storage memory; and
a recording unit which executes printing processing on the basis of the printing data drawn by the drawing unit.

2. An image printing apparatus having color materials of a plurality of colors and performing color printing using the plurality of color materials, the apparatus comprising:
a data acquisition interface which acquires color printing data;
a residual amount detection unit which detects the residual amount of the plurality of color materials;
a drawing unit which, when the residual amount detection unit has detected that the residual amount of at least one color material is a predetermined amount or less, draws the color printing data acquired by the data acquisition interface as printing data being printable with the other monochrome materials; and
a recording unit which executes printing processing on the basis of the printing data drawn by the drawing unit.

3. The image printing apparatus according to claim 2,
wherein, when the residual amount detection unit has detected that the residual amount of at least one color material other than black is a predetermined amount or less, the drawing unit draws the color printing data acquired by the data acquisition interface as printing data being printable with a black material.

4. The image printing apparatus according to claim 3, further comprising a color printing data storage memory which stores the color printing data until the end of printing,
wherein the drawing unit draws the color printing data stored in the color printing data storage memory as printing data being printable with a black material.

5. The image printing apparatus according to claim 4,
wherein the color printing data storage memory is an external storage unit.

6. The image printing apparatus according to claim 3,
wherein the color printing data is data being described in a page description language.

7. The image printing apparatus according to claim 3, further comprising a selection unit which selects whether creating printing data being printable with a black material or displaying information showing that color printing is impossible and printing processing will be stopped, when the residual amount detection unit has detected that the residual amount of a color material is a predetermined amount or less.

8. (canceled)

9. An image printing apparatus having color materials of a plurality of colors and performing color printing using the plurality of color materials, the apparatus comprising:
a data acquisition interface which acquires color printing data;
a drawing unit which draws printing data having a tone on the basis of the color printing data;
a drawn data storage memory which stores the printing data having a tone and being drawn by the drawing unit;
a residual amount detection unit which detects the residual amount of the plurality of color materials;
a data conversion unit which, when the residual amount detection unit has detected that the residual amount of at least one color material is a predetermined amount or less, converts the printing data having a tone and being stored in the drawn data storage memory to printing data being printable with the other monochrome materials; and
a recording unit which executes printing processing on the basis of the printing data converted by the data conversion unit.

10. The image printing apparatus according to claim 9,
wherein the plurality of color materials include black, and
wherein, when the residual amount detection unit has detected that the residual amount of at least one color material other than black is a predetermined amount or less, the data conversion unit converts the printing data having a tone and being stored in the drawn data storage memory to printing data being printable with a black material.

11. The image printing apparatus according to claim 10,
wherein the printing data having a tone is continuous tone printing data.

12. The image printing apparatus according to claim 10,
wherein the printing data having a tone is halftone printing data.

13. The image printing apparatus according to claim 10,
wherein the drawing data storage memory is an external storage unit.

14. (canceled)

15. An image printing apparatus having color materials of a plurality of colors and performing color printing using the plurality of color materials, the apparatus comprising:
a data acquisition interface which acquires drawn printing data having a tone and being created outside;
a drawn data storage memory which stores the drawn printing data having a tone and being acquired by the data acquisition interface;
a residual amount detection unit which detects the residual amount of the plurality of color materials;
a data conversion unit which, when the residual amount detection unit has detected that the residual amount of at least one color material is a predetermined amount or less, converts the printing data having a tone and being stored in the drawn data storage memory to printing data being printable with the other monochrome materials; and
a recording unit which executes printing processing on the basis of the printing data converted by the data conversion unit.

16. The image printing apparatus according to claim 15,
wherein the plurality of color materials include black, and
wherein, when the residual amount detection unit has detected that the residual amount of at least one color material other than black is a predetermined amount or less, the data conversion unit converts the printing data having a tone and being stored in the drawn data storage memory to printing data being printable with a black material.

17. The image printing apparatus according to claim 16,
wherein the printing data having a tone is continuous tone printing data.

18. The image printing apparatus according to claim 16,
wherein the printing data having a tone is halftone printing data.

19. The image printing apparatus according to claim 16,
wherein the drawing data storage memory is an external storage unit.

20-28. (canceled)

29. An image processing device comprising:
a first conversion unit which converts color halftone data to monochrome intermediate data; and
a second conversion unit which converts the monochrome intermediate data to monochrome halftone data by using an error diffusion method.

30. The image processing device according to claim 29,
wherein the second conversion unit uses a green noise error diffusion method.

31. The image processing device according to claim 29,
wherein the second conversion unit uses a blue noise mask method in place of the error diffusion method.

32. The image processing device according to claim 29,
wherein the second conversion unit uses a green noise mask method in place of the error diffusion method.

33. The image processing device according to claim 29,
wherein, when the color halftone data is multi value (N-value) data, the first conversion unit calculates pixel values of the monochrome intermediate data from multi-value levels of object pixels and color material densities.

34. (canceled)
